(19) United States
(12) Patent Application Publication
(10) Pub. No.: US 2025/0245631 A1
(43) Pub. Date: Jul. 31, 2025

(54) MAINTENANCE SCHEDULING USING EXPLAINABLE REINFORCEMENT LEARNING

(71) Applicant: Intelligent Fusion Technology, Inc., Germantown, MD (US)

(72) Inventors: Huong N. DANG, Germantown, MD (US); Kuo-Chu CHANG, Fairfax, VA (US); Simon KHAN, Rome, NY (US); Milvio FRANCO, Rome, NY (US); Erik BLASCH, Arlington, VA (US); Genshe CHEN, Germantown, MD (US); Hua-mei CHEN, Germantown, MD (US)

(21) Appl. No.: 18/428,822

(22) Filed: Jan. 31, 2024

(51) Int. Cl. G06Q 10/20; B64F 5/40; G06N 3/092

(52) U.S. Cl. CPC G06Q 10/20; B64F 5/40; G06N 3/092

(57) ABSTRACT

A method for aircraft maintenance scheduling includes using a scheduling environment as a reinforcement learning (RL) environment to simulate an operational concept, train an RL agent, and generate aircraft maintenance decisions and explanations; providing a decomposed reward Deep Q-Network (drDQN) algorithm, wherein the drDQN algorithm includes a first Deep Q-Network (DQN) and a second DQN; using the first DQN to maximize a mission accomplishment objective; using the second DQN to minimize a maintenance cost objective; providing a trained drDQN agent; using the trained drDQN agent to obtain the aircraft maintenance decisions and corresponding mission accomplishment and maintenance cost rewards; using a scheduling module to arrange aircraft maintenance activities; and using an explainable module to get reasons to detail why the decisions are made and present tradeoffs between the decisions and non-selected alternatives.

### GOVERNMENT RIGHTS

This invention was made with Government support under Contract No. FA8750-22-C-1004, awarded by the Air Force Research Laboratory of the United States (U.S.) Department of Defense. The U.S. Government has certain rights in the present disclosure.

### TECHNICAL FIELD

The present disclosure generally relates to the field of maintenance scheduling and, more particularly, relates to aircraft maintenance scheduling using explainable deep reinforcement learning methods.

### BACKGROUND

Aircraft maintenance scheduling aims to maximize operational effectiveness by maintaining a high level of mission readiness and simultaneously minimizing maintenance costs. In the military domain (as well as civil and commercial aviation sectors), a key objective is to ensure sufficient availability of aircraft to fulfill operational needs for a designated time period, e.g., 30 days. There are several methods for aircraft maintenance scheduling (AMS) such as optimization and machine learning methods. AMS can be formulated as a mixed-integer mathematical programming problem and solved using a classical Branch-and-Bound method [N. Safaei, et al. “Workforce-constrained maintenance scheduling for military aircraft fleet: A case study,” Annals of Operations Research, vol. 186, no. 1, 2011]. An E-Conservative model along with Monte-Carlo sampling or deep reinforcement learning (DRL) with neural networks can also be used to make maintenance decisions [H. Shahmoradi-Moghadam, et al. “Robust maintenance scheduling of aircraft fleet: A hybrid simulation-optimization approach,” IEEE Access, vol. 9, 2021]. While these methods provide scheduling solutions for maintenance, they do not give explanations for the selected actions. A lack of decision explanation can cause concerns, confusion, and ineffectiveness in implementing maintenance schedules.

The disclosed systems and methods are directed to solve one or more problems set forth above and other problems.

### BRIEF SUMMARY OF THE DISCLOSURE

In one aspect of the present disclosure, an explainable Deep Reinforcement Learning (XDRL) based method for aircraft maintenance scheduling includes providing a scheduling environment; using the scheduling environment as a reinforcement learning (RL) environment to simulate a fleet-level operational concept, train an RL agent, and generate aircraft maintenance decisions and explanations for human operators; providing a decomposed reward Deep Q-Network (drDQN) algorithm, wherein the drDQN algorithm includes two Deep Q-Networks (DQNs); using the first DQN to maximize a mission accomplishment objective; using the second DQN to minimize a maintenance cost objective; providing a trained drDQN agent; using the trained drDQN agent to obtain the aircraft maintenance decisions and corresponding mission accomplishment and maintenance cost rewards; providing a scheduling module; using the scheduling module to arrange aircraft maintenance activities for a predetermined period; providing an explainable module; and using the explainable module to explain why the decisions are made and present tradeoffs between the decisions and non-selected alternatives.

In another aspect of the present disclosure, an electronic device includes one or more processors; and a memory coupled to the one or more processors and storing computer programs that, when being executed, cause the one or more processors to perform arranging a scheduling environment; using the scheduling environment as an RL environment to simulate a fleet-level operational concept, train an RL agent, and generate aircraft maintenance decisions and explanations for human operators; providing a drDQN algorithm, wherein the drDQN algorithm includes two DQNs; using the first DQN to maximize a mission accomplishment objective; using the second DQN to minimize a maintenance cost objective; providing a trained drDQN agent; using the trained drDQN agent to obtain the aircraft maintenance decisions and corresponding mission accomplishment and maintenance cost rewards; providing a scheduling module; using the scheduling module to arrange aircraft maintenance activities for a predetermined period; providing an explainable module; and using the explainable module to explain why the decisions are made and present tradeoffs between the decisions and non-selected alternatives.

In another aspect of the present disclosure, a non-transitory computer readable storage medium contains computer programs. When being executed, the computer programs cause one or more processors of an electronic device to perform providing a scheduling environment; using the scheduling environment as an RL environment to simulate a fleet-level operational concept, train an RL agent, and generate aircraft maintenance decisions and explanations for human operators; providing a drDQN algorithm, wherein the drDQN algorithm includes two DQNs; using the first DQN to maximize a mission accomplishment objective; using the second DQN to minimize a maintenance cost objective; providing a trained drDQN agent; using the trained drDQN agent to obtain the aircraft maintenance decisions and corresponding mission accomplishment and maintenance cost rewards; providing a scheduling module; using the scheduling module to arrange aircraft maintenance activities for a predetermined period; providing an explainable module; and using the explainable module to explain why the decisions are made and present tradeoffs between the decisions and non-selected alternatives.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 is a diagram illustrating an operational concept of fleet-level military aircraft maintenance scheduling in accordance with various embodiments of the present disclosure;

FIG. 2 is a diagram illustrating a drDQN structure tailored for aircraft maintenance scheduling in accordance with various embodiments of the present disclosure;

FIG. 3 is a diagram illustrating total rewards of two drDQN agents in accordance with various embodiments of the present disclosure;

FIGS. 4A, 4B, and 4C are diagrams illustrating rewards of a drDQN agent in accordance with various embodiments of the present disclosure;

FIG. 5 is a diagram illustrating the total rewards of two drDQN agents in accordance with various embodiments of the present disclosure;

FIGS. 6A, 6B, and 6C are diagrams illustrating three reward types of two drDQN agentsin accordance with various embodiments of the present disclosure;

FIGS. 7A, 7B, and 7C are exemplary screenshots illustrating the content items of three tabs of a maintenance scheduling program in accordance with various embodiments of the present disclosure;

FIG. 8 is an exemplary screenshot illustrating the content items of another tab of the maintenance scheduling program in accordance with various embodiments of the present disclosure;

FIGS. 9A, 9B, 9C, 9D, and 9E are enlarged sections of the screenshot shown in FIG. 8 in accordance with various embodiments of the present disclosure;

FIG. 10 illustrates an exemplary method of aircraft maintenance scheduling in accordance with various embodiments of the present disclosure; and

FIG. 11 illustrates an overall structure of aircraft maintenance scheduling in accordance with various embodiments of the present disclosure.

### DETAILED DESCRIPTION

Reference will now be made in detail to exemplary embodiments of the disclosure, which are illustrated in the accompanying drawings.

The present disclosure provides an explainable Deep Reinforcement Learning (XDRL) based method for solving a problem of fleet-level aircraft maintenance scheduling optimization. The optimization problem considers various factors, such as an aircraft's initial status, mission requirements, maintenance resource capacity, and operational constraints, to create a maintenance schedule for a certain period. The schedule aims to balance both mission readiness and cost reduction. Further, an RL environment, such as a scheduling environment, is developed using an OpenAI Gym toolkit [G. Brockman, et al. “OpenAI gym,” arXiv preprint arXiv: 1606.01540, 2016]. The scheduling environment is highly flexible, allowing for easy extension to more complex scenarios and incorporating additional explanatory capabilities. One possible extension is an explainable RL capability which may be achieved by utilizing a drDQN algorithm. The drDQN algorithm may consist of two parts: a DQN that aims to maximize the mission accomplishment objective, and another DQN that aims to minimize the maintenance cost objective. As a result, the drDQN algorithm may generate real-time aircraft maintenance decisions, explain why decisions are selected, and present trade-offs between a chosen action and non-selected alternatives. The drDQN method may provide approximate solutions to an original DQN with a simpler structure while offering an ability to explain the decisions. In addition, a web-based program may be developed to provide an intuitive textual and visual user interface, making the drDQN method easy and convenient to use.

Optionally, a predictive remaining useful life (RUL) indicator is used. The RUL of each aircraft in a fleet may be used to guide maintenance scheduling. Further, the impact of maintenance actions on the mission readiness and cost reduction objectives may be analyzed, such as trade-offs associated with selecting one action over another action.

Optionally, a scheduling environment (e.g., a scheduling gym) may be created using the OpenAI Gym toolkit to simulate a maintenance scheduling scenario. The scheduling environment generates necessary objects based on an operator's configurations and executes corresponding responses and rewards when an RL agent applies an action to the environment.

The XDRL method for maintenance scheduling is based on the drDQN algorithm, which requires decomposing an RL agent's reward into a sum of different types of rewards, each focusing on a specific objective. The reward may be represented as a vector [symbol] =[R₁, R₂, . . . , R_{C}], where each element R_{c} represents a specific type of reward, and the total reward is the sum of all reward components R=Σ_{c=1}^{C} R_{c}. The drDQN algorithm produces Q_{c}values for each reward component R_{c}, and from these values, two explanation metrics are derived: Reward Difference explanation (RDX) and Minimal Sufficient explanation (MSX). Optionally, visualizations of three outcomes (Q-value, RDX, and MSX) may be designed. Intuitive visual comparisons between actions taken by the RL agent may be provided. Optionally, a summary text may be automatically generated in natural language that is easy for human operators to understand. The text is generated based on RDX values and the reward decomposition used in maintenance scheduling.

In some cases, maintenance scheduling is performed on a daily basis based on mission requirements, conditions of each aircraft, and resources in a maintenance facility. Each aircraft is grounded to perform a preventive maintenance process at specific intervals. It is desirable to ensure the continuous airworthiness of an aircraft, minimize the risk of unexpected failures from component deterioration, and maintain a consistent maintenance schedule for the entire fleet. The scheduling of maintenance checks is dependent on various factors such as the type and frequency of aircraft utilization and its age. Optionally, the RUL may be chosen as a primary indicator to guide maintenance scheduling. An aircraft must be grounded to perform the corresponding checks whenever it reaches the RUL limit. The maintenance scheduling may also take into consideration the mission requirements and available resources of a maintenance facility. Objectives of maintenance scheduling may include the completion of all the required mission tasks and minimum maintenance costs.

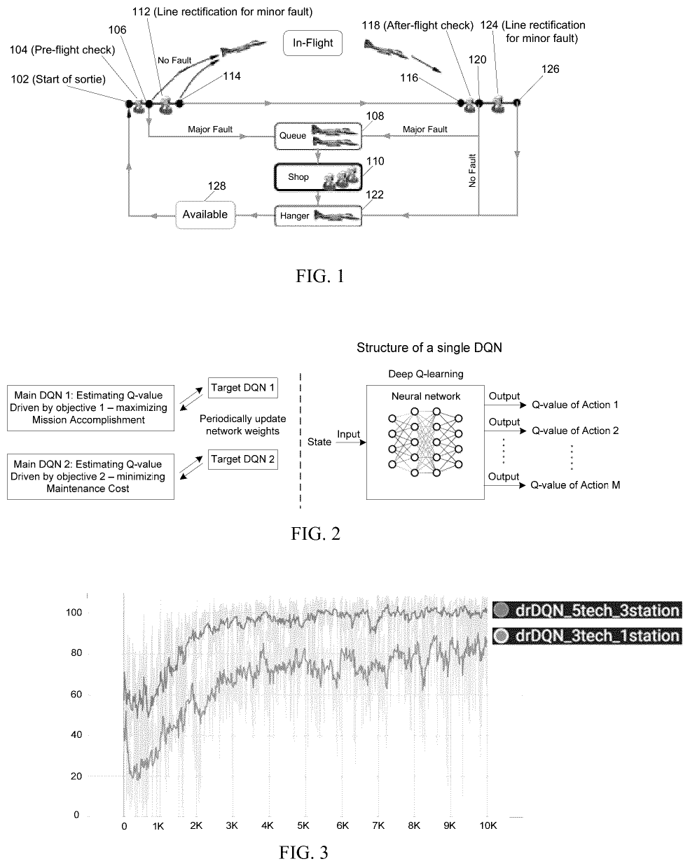

FIG. 1 shows a diagram illustrating an operational concept of fleet-level military aircraft maintenance scheduling in accordance with the present disclosure. In some cases, unexpected failures that may occur during aircraft missions are considered. As shown in FIG. 1, after an aircraft is assigned to a mission and starts a sortie at a position 102, a pre-flight check-up is conducted at a position 104. Once the pre-flight check-up is completed, the aircraft goes to a position 106. If there is a significant problem with the aircraft, it is sent to a repair queue at a position 108 and then a shop at a position 110 to be repaired. If there is no fault, it conducts a mission according to a plan. If a minor fault is detected at the pre-flight check-up, the aircraft is moved from the position 106 to a position 112 to get repaired at a line rectification. Then, the aircraft conducts the mission at a position 114. After the mission, the aircraft is moved from a position 116 to a position 118 and gets an after-flight check-up, similar to the pre-flight check-up at the position 104. It then goes to a position 120. Based on the test results, the aircraft goes to different places. When no fault is found, it goes to a readiness hangar at a position 122. When a major fault is detected, it goes to the repair queue at the position 108. When a minor fault is found, it goes to a position 124 to get fixed at another line rectification, before heading for a position 126 and then the readiness hangar at the position 122. The readiness hangar also receives repaired aircraft from the shop at the position 110. Further, some aircraft may be assigned to a position 128 before going to the position 102 for new tasks.

If there is a detected anomaly, the activity of moving the aircraft to the repair queue is called an unexpected failure repair to distinguish it from a preventive maintenance that an RL agent is responsible for scheduling. An aircraft under maintenance/repair stays in a station and remains unavailable for missions until the maintenance/repair is completed.

For maintenance scheduling, there are many sources of uncertainty in the environment. One of them is the randomness of the initial flight hours (FHs) of an aircraft, another is the randomness of health condition of the aircraft, and another is the randomness of mission requirements, from which others could be defined by an expert in the domain.

Optionally, a maintenance scheduling problem may be formulated as a Markov decision process, and an RL approach may be applied to solve it. The RL approach involves defining actions, formulating a state, and designing reward functions. In some cases, during the planning horizon, an RL agent makes a decision every day, which involves determining whether maintenance is required. If it is required, the agent selects an aircraft and schedules maintenance to be performed within a certain time period. Otherwise, if no maintenance is needed, the agent selects a “No Op.” action, indicating that no maintenance is to be performed. The aircraft scheduling state values include aircraft fleet RUL values, mission requirements (the required number of aircraft and duration), and an index of the current time.

The RL agent's objectives include determining a maintenance schedule for a fleet to support a mission and minimizing the maintenance cost. It is important to perform the maintenance at the right time. If the maintenance is not performed in time, unexpected aircraft failures may appear during a mission, which introduces additional risks to the mission. If preventive maintenance is performed too frequently, the maintenance costs would be high, and there may not be sufficient resources to accommodate maintenance tasks. If no resources are available for a scheduled maintenance task, the aircraft to be maintained would be put in a queue. Aircraft on a waiting list cannot execute any mission or receive maintenance during that time, which is a situation that should be minimized.

Mission accomplishment reward and maintenance cost reward are two notional reward types, which are defined to decompose an RL agent's reward into objective-centric reward types required by the drDQN algorithm. Given the required number of aircraft for mission ReqMission, the actual number of aircraft ready for mission ActMission, and the total number of aircraft in the fleet Acft, the mission accomplishment reward is defined by equation (1), and the maintenance cost reward is defined by equation (2).

$${r}_{mission} = \{ \begin{matrix}1 , & if ReqMission = 0 \\ \frac{ActMission}{ReqMission} * Acft , & otherwise\end{matrix} \qquad ( 1 )$$

$${r}_{cost} = \{ \begin{matrix}- 1 , & per a preventive maintenace \\ - 5 , & per an unexpected failure\end{matrix} \qquad ( 2 )$$

The scheduling environment is responsible for simulating the RL environment, training an RL agent, and generating sequential aircraft maintenance decisions and explanations for human operators. The scheduling environment infrastructure is designed to be flexible and scalable, allowing for the extension to more complex scenarios with additional explanation capabilities. Operators may create different environments by modifying the configurations. Four modules corresponding to four Python classes {aircraft status, health checker, maintenance shop, mission scheduler} with defined attributes and functions are constructed to emulate the roles of various objects in the environment.

For each of the four modules, certain configurations, such as an aircraft setting and a maintenance shop setting, need to be provided to initialize the corresponding scenarios. The aircraft setting defines the types of aircraft and the initial flight hours. The maintenance shop setting establishes a number of workstations and a number of technicians for each type of maintenance/repair.

Optionally, the mission planning setting defines mission requirements over a simulation period, including the number of aircraft and required mission duration. The scheduling environment may prepare an environment by initializing all the entities in the configuration based on a scenario's design. An environment simulation is performed in a discrete-time manner, where a simulation timeline is uniformly divided into small time steps (e.g., one day). At each time step, an RL agent may take an action, which is a maintenance item scheduled for the next few days (e.g., the next three days). After receiving the action, the environment may be updated based on the action, which includes computing rewards and updating a new state resulting from this action. The scheduling environment conducts the simulation sequentially until it reaches the end of the planning horizon.

The environment simulation process relies on the interaction between the four modules mentioned above {aircraft status, health checker, maintenance shop, mission scheduler}. The functions of the modules are described in detail below, where the terms in italics are properties involving computation or functions performing simulation actions.

The aircraft status module is designed to perform aircraft health degradation and interact with mission execution. Users may specify different aircraft types by defining Type, Maintenance Intervals, and other factors relevant to aircraft health degradation. The Maintenance Intervals are the suggested intervals for different types of aircraft. The user may create various aircraft entities by initializing aircraft with different IDs and flight hours (FHs). The aircraft's Current Health Condition is related to its FHs and RUL and is updated accordingly after a flight mission. If an aircraft's health status declines below a predefined Critical Health Condition, its Maintenance Condition will be updated, and its Rest Maintenance Time will start recording after a maintenance task is assigned. If an aircraft passes a pre-flight check, the Mission Condition will be updated, and the Rest Mission Time and Flight Hours will start to increment. In addition, the scheduling simulation is able to randomly initialize the flight hours for each Aircraft entity at the beginning of an RL trial. The generation of aircraft flight hours in a random manner increases the diversity of scenarios, enabling an RL agent to learn various aircraft states in a training process.

The health checker module is designed to perform a pre-flight check before a mission is executed by an aircraft and a post-flight check to determine the aircraft condition after a flight task. To check whether an aircraft is mission capable, the health checker module examines the health status of the aircraft by collecting its updated Current Health Condition and comparing it with the corresponding Critical Health Condition. If the aircraft's health status exceeds the critical health condition, it passes the check. Otherwise, it will be sent to a maintenance shop for repair.

The maintenance shop module arranges and implements a maintenance action at each time step (e.g., every day in a current setting). The maintenance shop module is characterized by several user-defined parameters, including Number of Workstations, Number of Technicians, and Current Maintenance Schedule from aggregated RL agent actions. At each time step, the maintenance shop module creates a task list for the current moment, including tasks from a mission scheduler and any unexpected maintenance requests from the health checker module. The maintenance shop module performs maintenance actions for the aircraft sequentially in a first-come-first-serve manner according to the Maintenance Queue within its full capacity.

The mission scheduler/distributor module is designed to generate mission requirements and allocate available aircraft to a mission. Similar to the randomly generated RUL for an Aircraft instance, introducing non-deterministic mission requirements adds to the variety of scenarios that an RL agent encounters during a training process. At the beginning of a simulation, a Mission Schedule and a Mission Duration Schedule are created based on user-configured Mission Required Aircraft Number Per Type and Mission Required Duration Per Type. The Mission Required Aircraft Number Per Type is a matrix that defines, for each aircraft type, the minimum value and maximum number of aircraft required to perform a mission per day. Similarly, the Mission Required Duration Per Type is a matrix that specifies the minimum and maximum duration required for executing a mission per day for each type of aircraft. According to these two specifications, the Mission Scheduler/Distributor module generates a mission requirement based on specified distributions. At each time step, the mission distributor identifies all available aircraft (not currently deployed on a mission or in maintenance) and assigns mission tasks to each aircraft. The selected aircraft must pass the pre-flight check to perform a mission. If an aircraft fails the pre-flight check, the mission distributor will search for other available aircraft until no aircraft can meet the current mission's needs.

An agent architecture, a policy learning process, and textual and visual explanation generation are illustrated in the descriptions below.

The drDQN algorithm consists of multiple DQN models, each serving as a Q-function Q_{C}^{π} in [symbol] (s,a)=[Q₁^{π}, Q₂^{π}, . . . , Q_{C}^{π}] that estimates the Q-value corresponding to each reward component R_{c}. During a policy learning process, the Q-value at each step is the summation of all Q_{c} as Q^{π}(s,a)=E_{c=1}^{C}Q_{c}^{π}. The optimal policy π selects an action with the highest Q-value.

FIG. 2 shows a diagram illustrating a drDQN structure arranged for aircraft maintenance scheduling in accordance with the present disclosure. As shown in FIG. 2, the structure of the drDQN algorithm consists of two main DQNs and two target DQNs, including a main DQN 1, a main DQN 2, a target DQN 1, and a target DQN 2. Each of the DQNs is based on neural networks. The main DQN 1 predicts Q-values driven by maximizing mission accomplishment reward. The main DQN 2 predicts Q-values driven by minimizing maintenance cost reward. In some cases, the use of neural networks to represent action values in RL policy learning may lead to instability due to the nonlinearity of the network. Training such a network requires a lot of data, and even then, there is no guarantee that the network may converge to an optimal value. To avoid situations where the network weights may oscillate or diverge due to a high correlation between actions and states, target DQNs 1 and 2 are used in the drDQN policy learning. The target DQNs may help stabilize the learning process.

Further, in some cases, reward decomposition may offer effective explanations regarding an RL agent's action preferences. As used herein, an RL agent is also referred to as a drDQN agent that is created based on the drDQN algorithm. A well-trained drDQN agent determines an optimal action for each day in the planning horizon and provides decomposed reward Q-value vectors for all possible actions [symbol] (s,aᵢ)=[Q₁^{π}, Q₂^{π}]. Based on a component Q-value, RDX and MSX metrics may be estimated to provide answers for certain questions, e.g., reasons behind the RL agent selecting one action instead of another, advantages and disadvantages of a selected action over other actions, and expected impact when a specific action is applied.

Further, an auto-generated summary text is proposed. The summary text is in natural language that may be understood by human operators easily. In addition, three graphs depicting the Q-value, RDX, and MSX are created to visualize comparisons of the agent's actions and their impact on the two objectives. The summary is automatically generated using rules defined in Table I and based on RDX values and reward decomposition designated to the maintenance scheduling scenario.

TABLE I
Template and Conditions for Explanations
TEMPLATE
On <Planning Date>, <Aircraft ID> is scheduled for
maintenance on <Selected Date>.
Compared with other choices, this decision has an advantage as <Text 1>.
However, it may <Text 2 >.
For more details, please see the below figures.

| | | |
|---|---|---|
| 1 | Condition | all (Δ₁(s, a*, aᵢ) > 0) AND not all (Δ₂(s, a*, aᵢ) > 0) |
| | Text 1 | it can maximize the mission accomplishment rate |
| | Text 2 | have a higher maintenance cost than other choices |
| 2 | Condition | all (Δ₂(s, a*, aᵢ) > 0) AND not all (Δ₁(s, a*, aᵢ) > 0) |
| | Text 1 | it can minimize the maintenance cost |
| | Text 2 | have a lower mission accomplishment rate than |
| | | other choices |
| 3 | Condition | Σ_{Δ} < ₀ Δ₁(s, a*, aᵢ) > Σ_{Δ} < ₀Δ₂(s, a*, aᵢ) |
| | Text 1 | has a higher mission accomplishment rate than |
| | | most other choices |
| | Text 2 | have a higher maintenance cost than some choices |
| 4 | Condition | Σ_{Δ} < ₀Δ₁(s, a*, aᵢ) < Σ_{Δ} < ₀Δ₂(s, a*, aᵢ) |
| | Text 1 | it reduces maintenance cost more than most |
| | | other choices |
| | Text 2 | have a lower mission accomplishment rate than |
| | | some choices |

Optionally, a designated drDQN agent for an aircraft maintenance scheduling problem is evaluated in a small-scale scenario. The scenario includes four aircraft. During a training process, hyperparameters of the drDQN algorithm are tuned. The hyperparameters include the number of episodes, the length of replay memory, a batch size, a learning rate, a decay rate of the learning rate, an exploration rate, the decay rate of the exploration rate, a gamma reward discount rate, the number of training steps required to update the target network, the number of hidden layers, and the number of neural units in each hidden layer. Each hyperparameter influences the agent's performance differently with different data types (i.e., integer, float). Manually achieving an optimal combination of these hyperparameters may be difficult. In some cases, an open-source library such as Optuna [Optuna contributors, “Optuna: A Next-generation Hyperparameter Optimization Framework,” 2021. [Online]] is used to select the best hyperparameter set that optimizes the model objective. Assuming an objective is to maximize the average total reward of the last 10% of episodes. To achieve the reward maximization objective, all RL agents presented are tuned using the Optuna method, and the reported performance is that of the resulting trained model.

As the scenario includes four aircraft, the maintenance scheduling environment settings are simplified to a fleet of four aircraft (e.g., two type-I and two type-II aircraft). Two drDQN agents were trained for 10,000 episodes in two distinct scheduling simulation environments with different maintenance resource capacities, such as (i) 3 technicians, 1 workstation; and (ii) 5 technicians, 3 workstations. FIG. 3 depicts the total rewards of a drDQN tech-1station agent and a drDQN-5tech-3station agent. The Y-axis refers to the total reward, while the X-axis refers to the number of training episodes. As shown in FIG. 3, the performance of the drDQN-3tech-1station line is worse than that of the drDQN-5tech-3station line. At the 10,000th episode, the total reward of the drDQN-3tech-1station agent is around 85, while the drDQN-5tech-3station agent achieves over 100. It indicates that maintenance resources have an impact on the total reward. It is clear that resources are insufficient in a scenario of four aircraft with a capacity of 3 technicians and 1 workstation. Some aircraft may be in the waiting queue, which results in a lower mission accomplishment rate. Considering that the highest possible total reward is 120 (4 aircraft×30 days), the drDQN-5tech-3station agent performs reasonably well in this scenario.

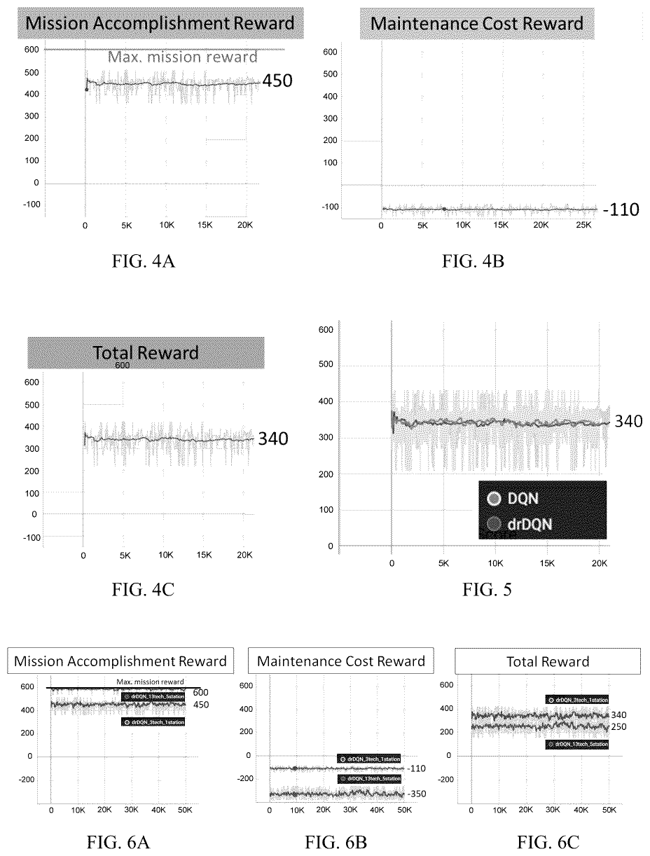

Exemplarily, another scenario includes a fleet of 20 aircraft (14 type-I and 6 type-II aircraft). First, a drDQN agent was trained for 20,000 episodes in a scheduling simulation environment with 20 aircraft, 3 technicians, and 1 workstation. FIGS. 4A-4C show the training performance of the agent in three graphs, Mission Accomplishment Reward, Maintenance CostReward, and Total Reward. The Y-axis refers to the reward score, while the X-axis refers to the number of training episodes. The score in the Mission Accomplishment Reward graph fluctuates at around 450. The score is reasonable compared with the maximum possible reward value of 600 (20 aircraft×30 days). The maintenance cost reward is about −110. Thus, the total reward score is approximately 340 when the two reward components are treated equally.

Exemplarily, the performance of the proposed drDQN agent and that of an original baseline DQN agent are compared in the same scheduling environment of 20 aircraft, 3 technicians, and 1 station. Results in FIG. 5 show that both have approximately the same total reward. It indicates that while the drDQN structure is more complex to equip the explanation capability, its performance is close to the baseline.

Exemplarily, a drDQN_13tech_5station agent is trained in a scheduling environment with 13 technicians and 5 workstations to evaluate how resource constraints affect performance. A drDQN_3tech_1station agent is trained in the scheduling environment with 3 technicians and 1 workstation. The two agents' performances are presented in FIGS. 6A and 6B.

As shown in FIG. 6A, the Mission Accomplishment Reward graph illustrates that the drDQN_13tech_5station agent outperforms the drDQN_3tech_1station agent with more resources (e.g., 600 vs. 450). The drDQN_13tech_5station agent's score nearly reaches the upper bound of the reward component. The high reward score is attributable to the available maintenance resources. When aircraft are maintained or repaired more quickly and ready for missions if needed, a higher mission accomplishment rate is achieved. However, in the Maintenance Cost Reward graph of FIG. 6B, the drDQN_13tech_5station agent receives a −350 score, much lower than that of the drDQN_3tech_1station agent (e.g., a score of nearly −110). The lower reward score is the consequence of that more resources are utilized when maintaining more aircraft, leading to higher maintenance costs.

As shown in FIG. 6C, the Total Reward graph indicates the total reward of the drDQN_3tech_1station agent is higher, with the two reward components weighted equally. However, if operators place a higher priority on the mission accomplishment rate (e.g., the weights of mission accomplishment reward and maintenance cost reward are set at 90% and 10%, respectively, which is not unusual in military operations), the total reward of the drDQN_13tech_5station agent would be much higher than that of the drDQN_3tech 1station agent.

The results illustrated above in the figures indicate that increasing maintenance resources helps fulfill mission accomplishment but may also cause higher maintenance costs and a lower total reward. It is a trade-off that operators may choose when faced with different operating environments and priorities.

Further, a web-based software program with an intuitive graphical user interface (GUI) is developed. The GUI features a robust fleet-level aircraft maintenance scheduling, action preference explanations via natural language summaries and visualized graphs, and informative environmental changes. The program may be developed using an open-source library (e.g., Dash [Plotly Technologies Inc., “Dash User Guide,” 2022. [Online]]) for creating interactive web-based visualizations. Four tabs may be configured in the GUI for operators. The tabs include AMS-Gym Configuration, Operator's Inputs, Maintenance Scheduling, and Environmental Changes, where the AMS-Gym is the scheduling environment illustrated above.

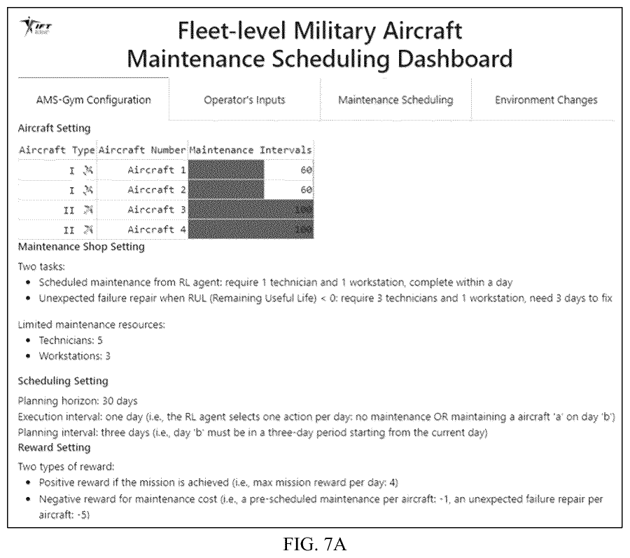

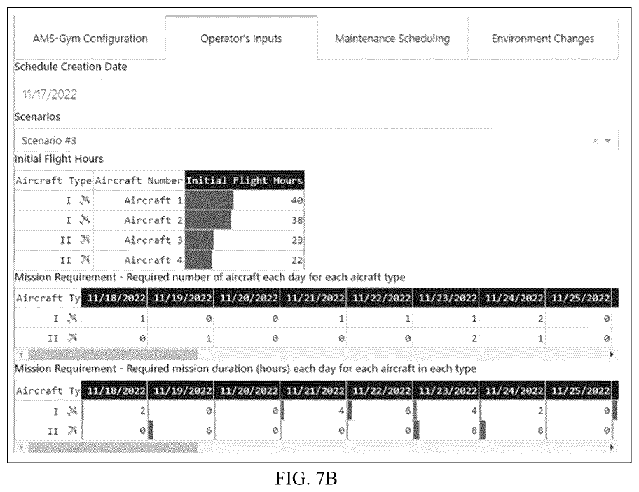

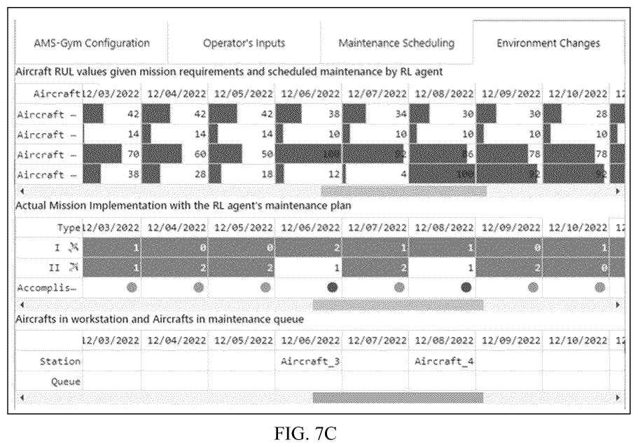

Screenshots in FIGS. 7A, 7B, 7C, and 8 illustrate content items under the four tabs, respectively. As shown in FIG. 7A, under the AMS-Gym Configuration tab, configurations of the AMS-Gym environment are illustrated, such as settings of the Aircraft Status Module, Maintenance Shop Module, Scheduling Mechanism, and Reward Components.

As shown in FIG. 7B, operators may use the Operator's Inputs tab to specify a schedule creation date, which should be the day before the first day of a planning horizon. Operators may also provide initial flight hours of the aircraft and mission requirements.

As shown in FIG. 7C, given the RL agent's maintenance schedule, the Environmental Changes tab provides informative data regarding environmental changes, such as whether an unexpected failure would happen, whether mission requirements would be accomplished, and if any aircraft would be placed in a maintenance queue.

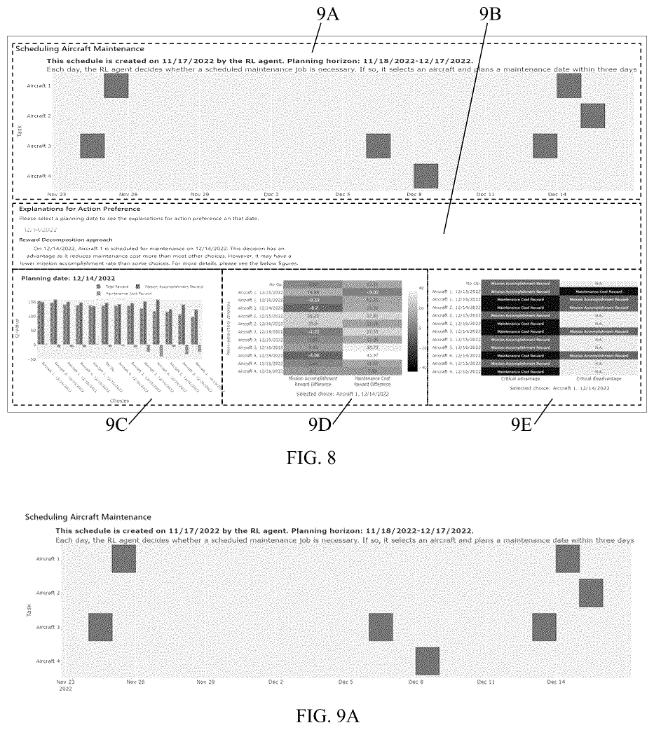

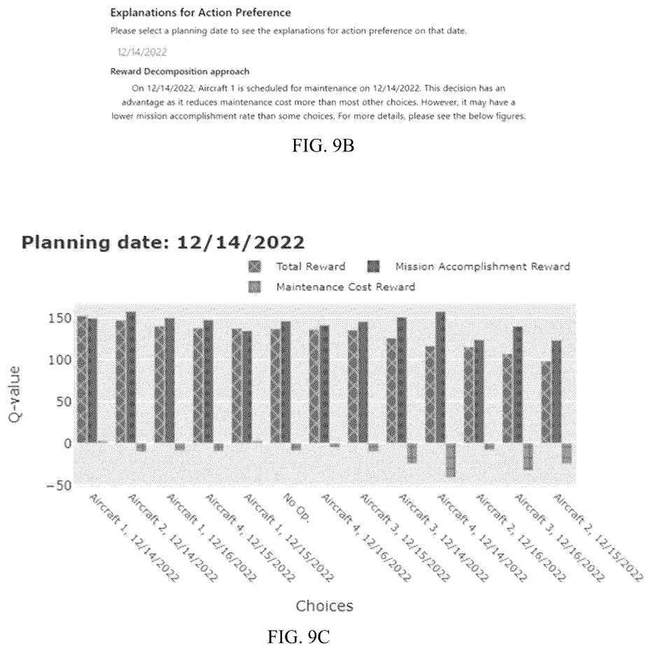

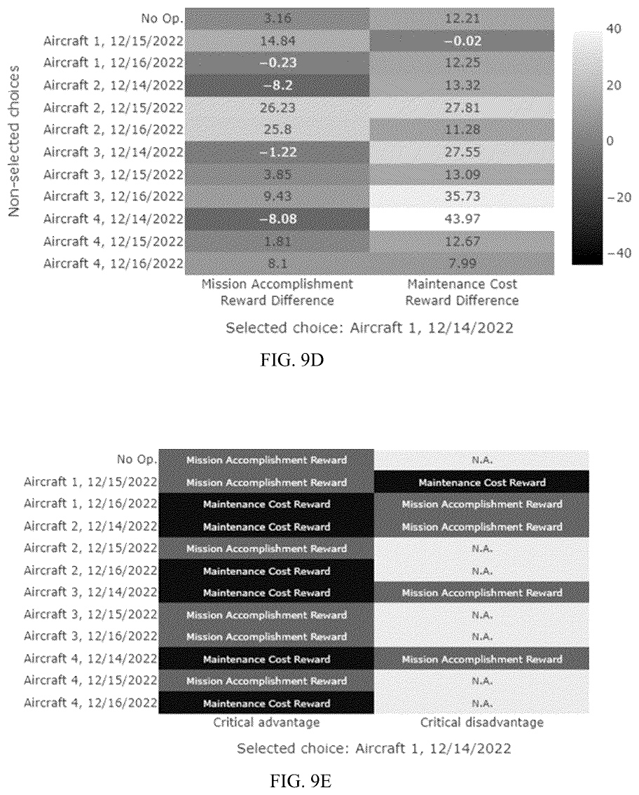

Content items under the Maintenance Scheduling tab are illustrated in a screenshot in FIG. 8. The screenshot contains sections 9A, 9B, 9C, 9D, and 9E. Enlarged pictures of the sections 9A-9E in FIG. 8 are shown in FIGS. 9A-9E, respectively. Once operators enter all required data, a ready-trained RL agent automatically schedules the aircraft maintenance as a timeline chart and explains its action automatically. Operators may select any time during the planning horizon, and then an explanation text summary appears in color (not shown) with three corresponding explainable figures (e.g., FIGS. 9C-9E). FIG. 9A corresponds to the section 9A in the upper portion of FIG. 8. FIG. 9B corresponds to the section 9B in the middle portion of FIG. 8. FIGS. 9C, 9D, and 9E correspond to the sections 9C, 9D, and 9E in the lower left, lower middle, and lower right portions of FIG. 8, respectively.

FIG. 9A depicts a schedule generated by the drDQN algorithm (or strategy), while FIG. 9B illustrates detailed explanations. Assuming the RL agent is a trained drDQN-5tech-3station agent as shown in FIG. 3. The RL agent automatically schedules an aircraft maintenance plan. In this scenario as depicted in FIG. 9A, the maintenance timeline is created on Nov. 17, 2022, and the planning horizon is from Nov. 18, 2022 to Dec. 17, 2022 (i.e., 30 days). The X-axis shows calendar dates during the planning horizon, while the Y-axis shows aircraft IDs. For each day, the RL agent decides whether any maintenance is necessary. If so, it selects an aircraft and plans a maintenance schedule within the next three days. For example, as shown in FIG. 9A, a bar indicates that aircraft 3 is scheduled for maintenance on November 24, while another bar indicates that aircraft 1 is scheduled for maintenance on December 14. If the RL agent decides not to perform maintenance on a particular day, no corresponding bar is displayed on the chart.

FIGS. 9C, 9D, and 9E exemplarily illustrate three visualized graphs for a decision on Dec. 14, 2022. As depicted in FIG. 9C, a Q-value graph presents predicted rewards of all possible choices. The Y-axis shows values of rewards, including Total Reward, Mission Accomplishment Reward, and Maintenance Cost Reward. The X-axis features 13 choices including “No Op.” and 12 distinct alternatives that are formed by combining four aircraft options with a 3-day planning interval. The order of choices from left to right corresponds to the descending order of Total Reward. The Q-value bar chart in FIG. 9C shows that the selected action (i.e., Aircraft 1, Dec. 14, 2022) has the highest total reward.

FIG. 9D shows a component reward difference graph. The graph is a heatmap (converted from a color picture) illustrating RDX values. The X-axis represents the selected choice, and the Y-axis represents 12 non-selected choices. The graph shows the reward difference values in terms of Mission Accomplishment objective and Maintenance Cost objective between a preferred choice and each non-selected choice with a pair-wise comparison. In the heatmap, the reward difference values may be either positive or negative. When the value is positive, it indicates that a selected choice has an advantage over a non-selected one. When the value is negative, it has a disadvantage. The higher the difference is, the better the preferred action is. The result displayed in the heatmap provides details to support the content of the textual summary. For the planning date 12/14, most values are positive for Maintenance Cost Reward Difference. For Mission Accomplishment Reward Difference, some values are negative, although their corresponding Maintenance Cost values are positive. Hence, as shown in FIG. 9B, the summary in natural language may state, “The decision has an advantage as it reduces maintenance cost more than most other choices. However, it may have a lower mission accomplishment rate than some choices”.

FIG. 9E shows a critical advantage and disadvantage graph illustrating MSX values. The graph presents the critical advantage and critical disadvantage of a selected choice compared with a non-selected choice. The critical advantage and critical disadvantage refer to the most essential strength and drawback of the favorable choice, when there are multiple strengths or drawbacks. The name of the critical objective is represented in a distinct color in each cell of this table. When the Reward Difference values of both Mission Accomplishment and Maintenance Cost are either positive or negative, the MSX value table is useful for conveying the essential advantage or disadvantage of an action to the operator. For example, on the planning date 12/14, if the chosen action is compared with the action “No Op.”, even though both the Mission Accomplishment and Maintenance Cost reward discrepancies are favorable, the Mission Accomplishment Reward is the one with the critical advantage.

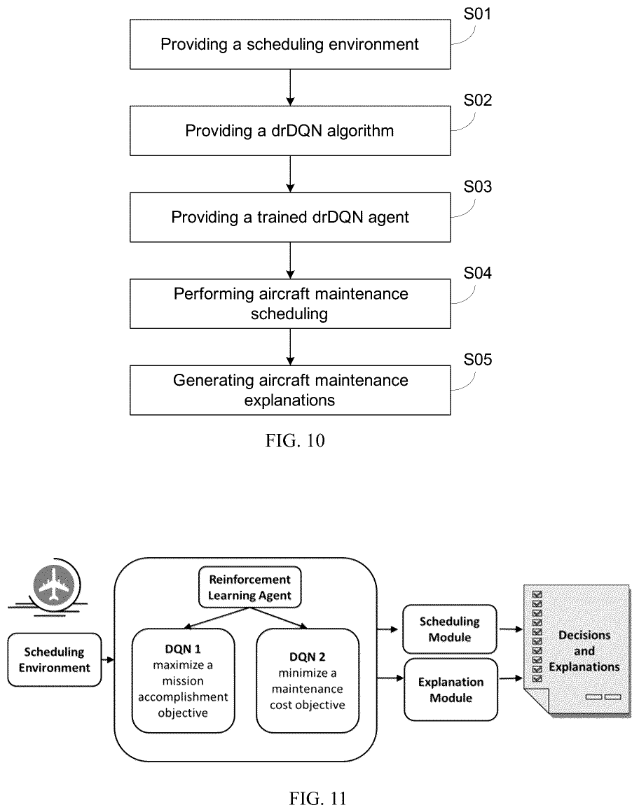

FIG. 10 shows a schematic flow chart to illustrate XDRL based methods for aircraft maintenance scheduling according to the present disclosure. At S01, a scheduling environment (e.g., the AMS-Gym shown in FIG. 7A) is provided. The scheduling environment is created using the OpenAI Gym toolkit. The scheduling environment is used as an RL environment to simulate a fleet-level operational concept (e.g., a fleet-level military operational concept), train a drDQN agent, and generate aircraft maintenance decisions and explanations. Four scheduling modules {aircraft status, health checker, maintenance shop, mission scheduler} with defined attributes and functions are configured. The scheduling modules define mission requirements, arrange and conduct pre-flight checks and post-flight checks, implement maintenance actions, and allocate available aircraft to missions.

At S02, a drDQN algorithm is provided. The drDQN algorithm is installed on a system that contains a server or a processing chip. The drDQN algorithm includes the first DQN (e.g., the main DQN 1 in FIG. 2) and the second DQN (e.g., the main DQN 2 in FIG. 2). The first DQN is used to maximize the mission accomplishment objective, and the second DQN is used to minimize the maintenance cost objective.

At S03, a trained drDQN agent (e.g., the drDQN-5tech-3station agent associated with FIG. 3) is provided. The drDQN agent is trained according to specific environmental factors such as the number of aircraft, the number of technicians, the number of workstations, etc. An aircraft maintenance schedule, a mission accomplishment reward, and a maintenance cost reward are obtained using the trained drDQN agent. The scheduling environment, drDQN algorithm, and drDQN agent may be stored at the server, the processing chip, or a memory module connected with the server or processing chip.

At S04, a scheduling module is provided and aircraft maintenance scheduling is performed using the scheduling module. Maintenance scheduling decisions are obtained using the trained drDQN agent simulated in the scheduling environment. For example, aircraft maintenance scheduling may be conducted to arrange maintenance activities for a specified period.

At S05, an explainable module is provided and aircraft maintenance explanations are generated using the explainable module. The explanations provide reasons that indicate why the decisions were selected or made and present tradeoffs between the chosen decisions and non-selected alternatives. The trained drDQN agent may be used to calculate the mission accomplishment and maintenance cost rewards. A total reward may be calculated based on the the mission accomplishment and maintenance cost rewards (i.e., a mission accomplishment reward and a maintenance cost reward). The total reward, mission accomplishment reward, and maintenance cost reward may be used to compute RDX and MSX for explaining maintenance scheduling decisions. RDX values are used to generate a summary text in natural language for operators to read explanations easily and conveniently. The summary text may be presented in a GUI of the system using a display device. The total reward, mission accomplishment reward, and maintenance cost reward may be illustrated via a bar chart in the GUI, and the RDX and MSX values may also be used to create two heatmaps for displaying comparisons of different choices in the GUI.

FIG. 11 illustrates the overall structure of the XDRL methods for aircraft maintenance scheduling according to the present disclosure. A scheduling environment is created to simulate a fleet-level operational concept, train a drDQN agent, and generate aircraft maintenance decisions and explanations. A drDQN algorithm includes two DQNs: the first DQN is used to maximize a mission accomplishment objective, and the second DQN is used to minimize a maintenance cost objective. An aircraft maintenance schedule, a mission accomplishment reward, and a maintenance cost reward are obtained using the trained drDQN agent. A scheduling module is provided, and aircraft maintenance scheduling is performed using the scheduling module. An explainable module is provided, and aircraft maintenance explanations are generated using the explainable module.

In some embodiments, an electronic device is used for aircraft maintenance scheduling. The device may include a server or one or more processors, the scheduling environment, the drDQN algorithm, and the drDQN agent. The drDQN algorithm contains a DQN for maximizing the mission accomplishment objective and another DQN for minimizing the maintenance cost objective. The scheduling environment, the drDQN algorithm, and the drDQN agent are stored at the server, one or more processors, or a memory module connected to the server or the one or more processors. The aircraft maintenance scheduling is performed based on the scheduling environment, the drDQN algorithm, and the drDQN agent with the above-illustrated methods. For example, certain computer programs may be stored in the memory module. When the computer programs are executed, it causes the server or one or more processors to perform aircraft maintenance scheduling using the methods described above.

Therefore, as illustrated above, explainable RL methods and devices are disclosed for aircraft maintenance scheduling. These methods and devices may be used to solve the challenges of scheduling maintenance for aircraft at the fleet level, along with offering clear and intuitive textual and visual explanations. The scheduling environment is constructed as an RL environment using the OpenAI Gym toolkit. In the scheduling environment, four modules with defined attributes and functions are constructed. The architecture of this environment is built to be flexible and expandable, enabling it to cater to more complex scenarios while also incorporating further explanation capabilities. To facilitate the explainable RL capability, the drDQN algorithm is utilized, which combines a DQN for maximizing mission accomplishment with another DQN for minimizing maintenance costs. An aircraft maintenance schedule and explanations are provided using the scheduling environment and the drDQN agent.

The embodiments disclosed herein are exemplary only. Other applications, advantages, alternations, modifications, or equivalents to the disclosed embodiments are obvious to those skilled in the art and are intended to be encompassed within the scope of the present disclosure.

What is claimed is:

1. An explainable Deep Reinforcement Learning (XDRL) based method for aircraft maintenance scheduling, comprising:
providing a scheduling environment;
using the scheduling environment as a reinforcement learning (RL) environment to simulate a fleet-level operational concept, train an RL agent, and generate aircraft maintenance decisions and explanations for human operators;
providing a decomposed reward Deep Q-Network (drDQN) algorithm, the drDQN algorithm including a plurality of Deep Q-Networks (DQNs) comprising a first DQN and a second DQN;
using the first DQN to maximize a mission accomplishment objective;
using the second DQN to minimize a maintenance cost objective;
providing a trained drDQN agent;
using the trained drDQN agent to obtain the aircraft maintenance decisions and corresponding mission accomplishment and maintenance cost rewards;
providing a scheduling module;
using the scheduling module to arrange aircraft maintenance activities for a predetermined period;
providing an explainable module; and
using the explainable module to get a reason to explain why the decisions are made and present a tradeoff between the decisions and non-selected alternatives.

2. The method according to claim 1, further comprising:
obtaining Reward Difference explanation (RDX) and Minimal Sufficient explanation (MSX); and
using the RDX and MSX to obtain the aircraft maintenance explanations.

3. The method according to claim 2, further comprising:
using a plurality of RDX values to obtain a summary text generated in natural language; and
presenting the summary text in a graphical user interface (GUI).

4. The method according to claim 1, wherein the scheduling environment is created using an OpenAI Gym toolkit.

5. The method according to claim 1, further comprising:
calculating a total reward using the mission accomplishment and maintenance cost rewards.

6. The method according to claim 5, further comprising:
calculating the total reward using a first weight and a second weight of the mission accomplishment and maintenance cost rewards, the first weight being larger than the second weight.

7. The method according to claim 5, further comprising:
presenting the total reward and the mission accomplishment and maintenance cost rewards in a graphical user interface (GUI).

8. An electronic device for aircraft maintenance scheduling, comprising:
one or more processors; and
a memory coupled to the one or more processors and storing computer programs that, when being executed, cause the one or more processors to perform:
providing a scheduling environment;
using the scheduling environment as a reinforcement learning (RL) environment to simulate a fleet-level operational concept, train an RL agent, and generate aircraft maintenance decisions and explanations for human operators;
providing a decomposed reward Deep Q-Network (drDQN) algorithm, the drDQN algorithm including a plurality of Deep Q-Networks (DQNs) comprising a first DQN and a second DQN;
using the first DQN to maximize a mission accomplishment objective;
using the second DQN to minimize a maintenance cost objective;
providing a trained drDQN agent;
using the trained drDQN agent to obtain the aircraft maintenance decisions and corresponding mission accomplishment and maintenance cost rewards;
providing a scheduling module;
using the scheduling module to arrange aircraft maintenance activities for a predetermined period;
providing an explainable module; and
using the explainable module to get a reason to explain why the decisions are made and present a tradeoff between the decisions and non-selected alternatives.

9. The device according to claim 8, wherein the one or more processors are further configured to perform:
obtaining Reward Difference explanation (RDX) and Minimal Sufficient explanation (MSX); and
using the RDX and MSX to obtain the aircraft maintenance explanations.

10. The device according to claim 9, wherein the one or more processors are further configured to perform:
using a plurality of RDX values to obtain a summary text generated in natural language; and
presenting the summary text in a graphical user interface (GUI).

11. The device according to claim 8, wherein the scheduling environment is created using an OpenAI Gym toolkit.

12. The device according to claim 8, wherein the one or more processors are further configured to perform:
calculating a total reward using the mission accomplishment and maintenance cost rewards.

13. The device according to claim 12, wherein the one or more processors are further configured to perform:
calculating the total reward using a first weight and a second weight of the mission accomplishment and maintenance cost rewards, the first weight being larger than the second weight.

14. The device according to claim 12, wherein the one or more processors are further configured to perform:
presenting the total reward and the mission accomplishment and maintenance cost rewards in a graphical user interface (GUI).

15. A non-transitory computer readable storage medium, containing computer programs that, when being executed, cause one or more processors of an electronic device to perform:
providing a scheduling environment;
using the scheduling environment as a reinforcement learning (RL) environment to simulate a fleet-level operational concept, train an RL agent, and generate aircraft maintenance decisions and explanations for human operators;
providing a decomposed reward Deep Q-Network (drDQN) algorithm, the drDQN algorithm including a plurality of Deep Q-Networks (DQNs) comprising a first DQN and a second DQN;
using the first DQN to maximize a mission accomplishment objective;
using the second DQN to minimize a maintenance cost objective;
providing a trained drDQN agent;
using the trained drDQN agent to obtain the aircraft maintenance decisions and corresponding mission accomplishment and maintenance cost rewards;
providing a scheduling module;
using the scheduling module to arrange aircraft maintenance activities for a predetermined period;
providing an explainable module; and
using the explainable module to get a reason to explain why the decisions are made and present a tradeoff between the decisions and non-selected alternatives.

16. The storage medium according to claim 15, wherein the one or more processors are further configured to perform:
obtaining Reward Difference explanation (RDX) and Minimal Sufficient explanation (MSX); and
using the RDX and MSX to obtain the aircraft maintenance explanations.

17. The storage medium according to claim 16, wherein the one or more processors are further configured to perform:
using a plurality of RDX values to obtain a summary text generated in natural language; and
presenting the summary text in a graphical user interface (GUI).

18. The storage medium according to claim 15, wherein the one or more processors are further configured to perform:
calculating a total reward using the mission accomplishment and maintenance cost rewards.

19. The storage medium according to claim 18, wherein the one or more processors are further configured to perform:
calculating the total reward using a first weight and a second weight of the mission accomplishment and maintenance cost rewards, the first weight being larger than the second weight.

20. The storage medium according to claim 18, wherein the one or more processors are further configured to perform:
presenting the total reward and the mission accomplishment and maintenance cost rewards in a graphical user interface (GUI).
